(19) United States
(12) Patent Application Publication
(10) Pub. No.: US 2005/0143843 A1
(43) Pub. Date: Jun. 30, 2005

(54) Command pacing

(76) Inventors: Zohar Bogin, Folsom, CA (US); Arthur D. Hunter JR., Cameron Park, CA (US); Krishnamurthy B. Venkataramana, Folsom, CA (US); Mihir Shah, Philadolphia, PA (US)

Correspondence Address: INTEL CORPORATION, P.O. BOX 5326, SANTA CLARA, CA, 95056-5326, US

(21) Appl. No.: 10/723,132

(22) Filed: Nov. 25, 2003

(51) Int. Cl. G05B 11/01

(52) U.S. Cl. 700/20

(57) ABSTRACT

Machine-readable media, methods, and apparatus are described to pace commands to codecs. Some embodiments comprise an audio controller that transfers frames to codecs and places commands in the frames at a pace dictated by a command pacer.

### BACKGROUND

A computing device may comprise an audio controller that streams audio to and/or from codecs of the computing device via an audio bus. As a result of streaming the audio, the audio controller may send commands to one or more codecs. Each codec may in turn send the audio controller a response as solicited by the commands. Because some codecs may take longer to process a command and return a response than other codecs, a series of commands may result in the audio controller receiving a burst of responses. The burst of responses may overflow a buffer used to store the responses, thus resulting in one or more responses being lost.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale.

For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing device with an audio controller having a command pacer.

FIG. 2 illustrates an embodiment of a command buffer and a response buffer used by the audio controller.

FIG. 3 illustrates an embodiment of a frame used by the audio controller to transfer data with codecs of the computing device.

FIG. 4 illustrates an embodiment of a command pacer of the audio controller.

FIG. 5 illustrates an embodiment of a method to stream data and commands to the codecs of the computing device.

FIG. 6 illustrates an embodiment of a method to stream data and responses from the codecs to the memory of the computing device.

### DETAILED DESCRIPTION

The following description describes command pacing techniques. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included. descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and, others.

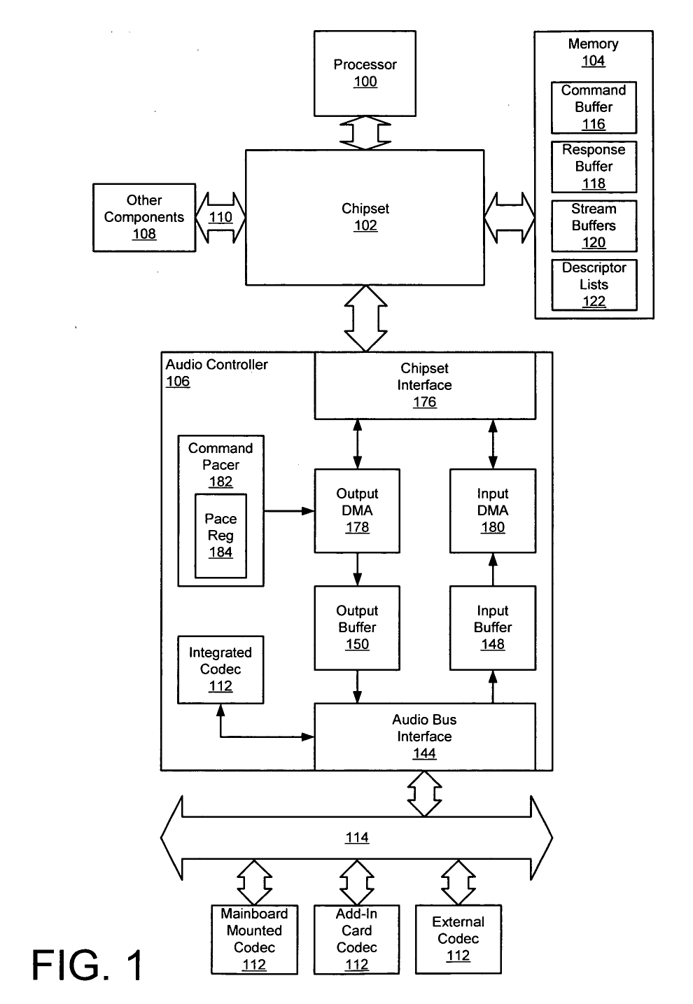

An embodiment of a computing device is shown in FIG. 1. The computing device may comprise one or more processors 100 and a chipset 102. The chipset 102 may include one or more integrated circuit packages or chips that couple the processor 100 to a memory 104 and an audio controller 106. The chipset 102 may further couple the processor 100 to other other components 108 such as, for example, BIOS firmware, keyboards, mice, storage devices, network interfaces, etc. via one or more buses 110.

The computing device may further comprise one or more codecs 112 coupled to the audio controller 106 via an audio bus 114. The audio controller 106 may be integrated into the chipset 102. However, in the depicted embodiment, the audio controller 106 is separate from the chipset 102. Similarly, the codecs 112 may be integrated into the audio controller 106 and/or chipset 102, may be mounted to a mainboard of the computing device, may be mounted to an add-in card that is coupled to the computing device, and/or may be part of an external device such as, for example, a docking station, audio mixer, etc that is coupled to an interface port (not shown) of the computing device. Further, the codecs 112 may be associated with sound cards, modems, facsimile devices, telephony devices, audio capture devices, video capture devices, etc. of the computing device that generate and/or process streams of data.

The memory 104 may comprise one or more memory devices that provide addressable storage locations from which data may be read and/or to which data may be written. The memory 104 may also comprise one or more different types of memory devices such as, for example, DRAM (Dynamic Random Access Memory) devices, SDRAM (Synchronous DRAM) devices, DDR (Double Data Rate) SDRAM devices, or other volatile and/or non-volatile memory devices. In one embodiment, the memory 104 may store a command buffer 116, a response buffer 118, stream buffers 120, and buffer descriptor lists 122 as well as other data structures and/or software modules such as, for example, an operating system, device drivers, and/or applications.

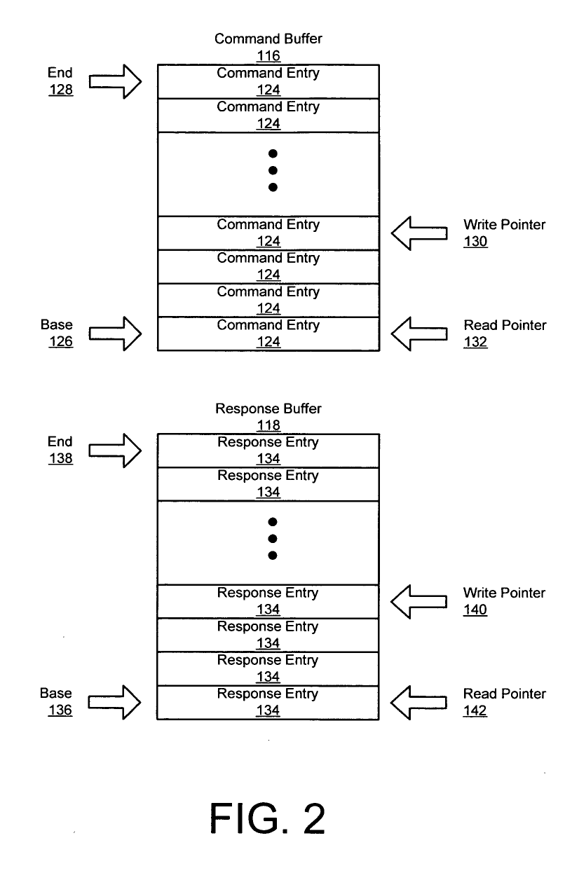

As shown in FIG. 2, the command buffer 116 may comprise several command entries 124 that span from a base 126 to an end 128. A write pointer 130 and a read pointer 132 may be associated with the command buffer 116. In one embodiment, the processor 100 may write a command for one or more codecs to the command entry 124 identified by the write pointer 130. In response to writing a command to the command entry 124 identified by the write pointer 130, the processor 100 may update the write pointer 130 such that the write pointer 130 identifies a subsequent command entry 124 of the command buffer 116. Further, the processor 100 may update the write pointer 130 such that the write pointer 130 identifies the command entry 124 associated with the base 126 of the command buffer 116 in response to writing to the command entry 124 associated with the end 128 of the command buffer 116.

In one embodiment, the audio controller 106 may read a command for one or more codecs from the command entry 124 identified by the read pointer 132. The audio controller 106 in response to reading from the command buffer 116 may update the read pointer 132 such that the read pointer 132 identifies a subsequent command entry 124 of the command buffer 116. Further, the audio controller 106 may update the read pointer 132 such that the read pointer 132 identifies the command entry 124 associated with the base 126 of the command buffer 116 in response to reading from the command entry 124 associated with the end 128 of the command buffer 116.

Further, as shown in FIG. 2, the response buffer 118 may comprise several response entries 134 that span from a base 136 to an end 138. A write pointer 140 and a read pointer 142 may be associated with the response buffer 118. In one embodiment, the processor 100 may read a response of a codec 112 from the response entry 134 identified by the read pointer 142. In response to reading a response from the response entry 134 identified by the read pointer 142, the processor 100 may update the read pointer 142 such that the read pointer 142 identifies a subsequent response entry 134 of the response buffer 118. Further, the processor 100 may update the read pointer 142 such that the read pointer 142 identifies the response entry 134 associated with the base 136 of the response buffer 118 in response to reading from the response entry 134 associated with the end 138 of the response buffer 118.

In one embodiment, the audio controller 106 may write a response of a codec 112 to the response entry 134 identified by the write pointer 140. The audio controller 106 in response to writing to the response buffer 118 may update the write pointer 140 such that the write pointer 140 identifies a subsequent response entry 134 of the response buffer 118. Further, the audio controller 106 may update the write pointer 140 such that the write pointer 140 identifies the response entry 134 associated with the base 136 of the response buffer 118 in response to writing from the response entry 134 associated with the end 138 of the response buffer 118.

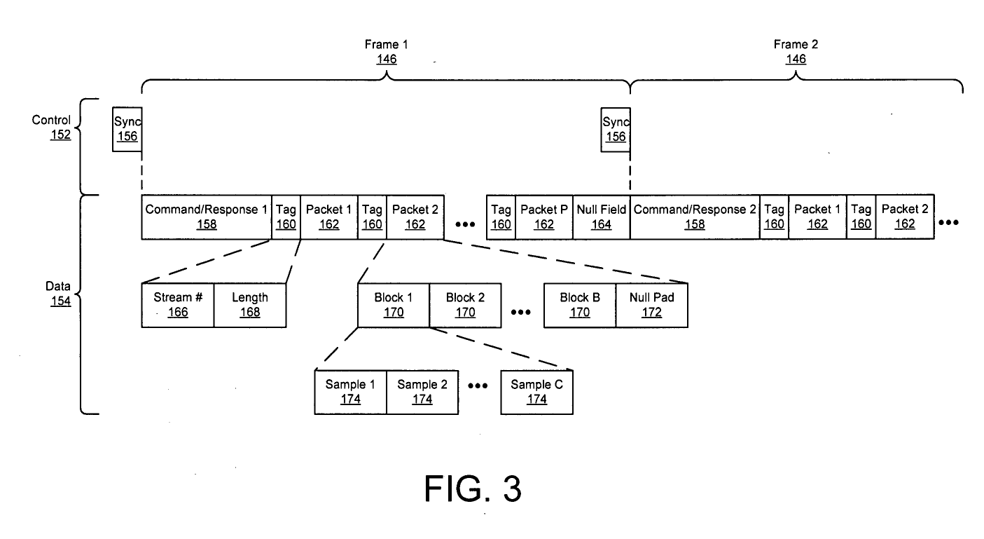

Referring back to FIG. 1, the audio controller 106 may comprise an audio bus interface 144 to transfer frames 146 (See, FIG. 3) with the codecs 112 via the audio bus 114. In one embodiment, the audio bus interface 144 may receive frames 146 of data from the codecs 112 via one or more point-to-point serial input links of the audio bus 114 and may store the received frames 146 in an input buffer 148 of the audio controller 106. Further, the audio bus interface 144 may take frames 146 from an output buffer 150 of the audio controller 106 and may send the created frames 146 to one or more of the codecs 112 via a broadcast serial output link of the audio bus 114.

As illustrated in FIG. 3, the frames 146 of the audio bus 114 may be defined by control signals 152 of an audio bus control link and data signals 154 of an audio bus serial data input link. In particular, the control signals 152 may comprise frame syncs 156 to indicate the start of a frame 146. As illustrated, a frame 146 may comprise a command/response field 158, one or more stream tags 160, one or more packets 162 and an optional null field 164. The command/response field 158 may comprise a command that requests a receiver of the frame 146 to perform some action and/or may comprise a response to a command of a previous frame 146.

In general, the stream tags 160 may indicate the start of a packet 162, may identify to which stream the packet 162 is associated, and may indicate a length of the packet 162. In one embodiment, each stream tag 160 of the frame 146 may comprise a stream identifier (ID) 166 that indicates to which stream the packet 162 is associated. Further, each stream tag 160 may comprise an actual packet length 168 that indicates the length (e.g. number of bytes) of the following packet 162. The stream tags 160 may permit a codec 112 to transfer multiple streams and/or multiple packets 162 of a single stream during a single frame 146. Further, the null field 164 may comprise pad bits/bytes that extend the frame 146 to a fixed length or a multiple of some frame unit length. In another embodiment, the null field 164 may be associated with a quiescent period of an audio link in which no data is transmitted.

As shown, each packet 162 may comprise one or more sample blocks 170 and an optional null pad 172. The null pad 172 may pad the packet 162 to a fixed packet length or to a multiple of some packet unit length. In another embodiment, the null pad 172 may be associated with a quiescent period of an audio link in which no data is transmitted. Each sample block 170 of a packet 162 may comprise a separate sample 174 for each channel of a plurality of channels. For example, a stereo sample block 170 may comprise right channel sample 174 and left channel sample 174 that are associated with the same sample point in time of a stereo audio signal. Similarly, a 5.1 sample block 170 may comprise center channel sample 174, front right channel sample 174, front left channel sample 174, back right channel sample 174, back right channel sample 174, and bass channel sample 174 that are associated with the same sample point in time of a 5.1 channel audio signal.

Referring again to FIG. 1, the audio controller 106 may further comprise a chipset interface 176, one or more output direct memory access (DMA) controllers 178, and one or more input DMA controllers 180 In one embodiment, an output DMA controller 178 of the audio controller 106 may read data from stream buffer 120 of the memory 104 via the chipset interface 176 in accordance to a buffer descriptor list 122 that defines the stream buffer 120. The output DMA controller 178 may further read commands from the command buffer 116 of the memory 104. In one embodiment, the output DMA controller 178 may read a command 116 from a command entry 124 identified by the read pointer 132 and may update the read pointer 132 such that the read pointer 132 identifies the subsequent command entry 124 of the command buffer 116. The output DMA controller 178 may then create frames 146 from the data read from its stream buffer 120 and commands read from the command buffer 116 and may store the created frames 146 in the output buffer 150 for delivery to one or more codecs 112.

An input DMA controller 180 may take a frame 146 from the input buffer 148 of the audio controller 106 and may write data of the frame 146 to a stream buffer 120 of the memory 104 via the chipset interface 176. In one embodiment, the input DMA controller 180 may write the data in accordance to a buffer descriptor list 122 that defines the stream buffer 120. The input DMA controller may also write responses of the frame 146 to the response buffer 118 of the memory 104. In one embodiment, the input DMA controller 180 may write a response to a response entry 134 identified by the write pointer 140 and may update the write pointer 140 such that the write pointer 140 identifies the subsequent response entry 134 of the response buffer 118.

The audio controller 106 may further comprise a command pacer 182 to pace the rate at which the output DMA controller 178 places commands in the output buffer 150. In one embodiment, the command pacer 182 may pace the commands in an attempt to prevent overruns due to responses from the codecs 112. Further, the command pacer 182 in one embodiment may control or set the command pace based upon a pace value stored in a pace register 184 of the audio controller 106. In one embodiment, the command pacer 182 may generate a signal that allows the output DMA controller 178 to store commands in the output buffer 150 for a first number of frames 146 and that blocks the output DMA controller 178 from storing further commands in the output buffer 150 for a second number of frames 146. By controlling the generation of the signal, the command pacer 182 may control the rate at which commands are delivered to the codecs 112 and indirectly the rate at which responses are received from the codecs 112.

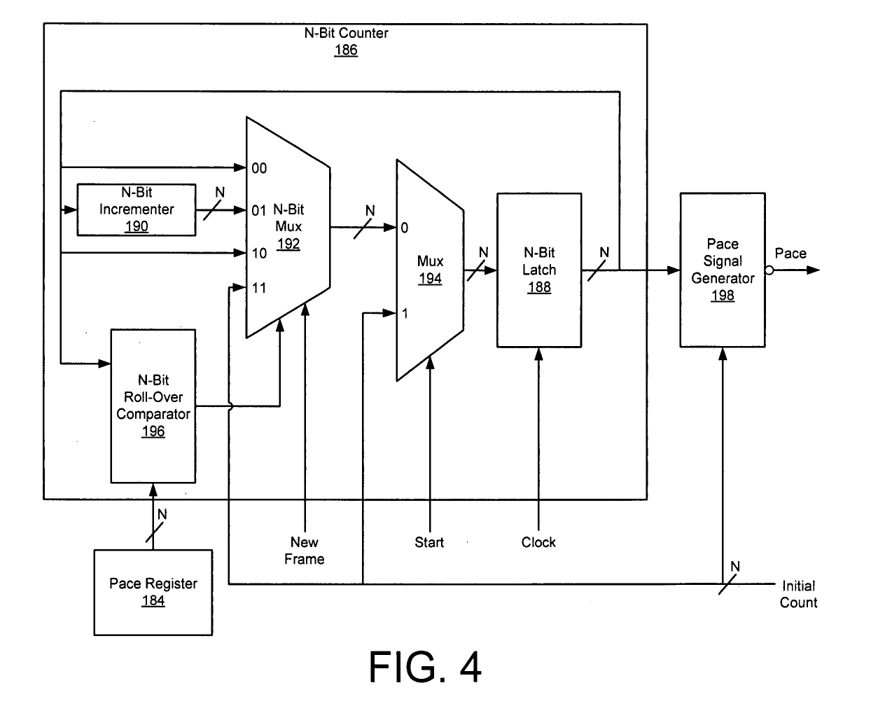

One embodiment of the command pacer 182 is illustrated in FIG. 4. The command pacer 182 of FIG. 4 may comprise an N-bit roll-over counter 186 with a programmable roll-over value. As depicted, the counter 186 may comprise an N-bit latch 188 to store the count of the counter 186. In one embodiment, the latch 188 may update its count by loading a next count received via an input of the latch 188 in response to each cycle of a clock signal.

The counter 186 may further comprise an N-bit incrementer 190 that receives the count from the latch 188 and provides an N-bit multiplexer 192 of the counter 186 with an incremented count. The N-bit multiplexer further may receive the current count of the latch 188 and an initial count (e.g. 0) for the counter 186. Based upon control signals, the multiplexer 192 may select the initial count, current count, or the incremented count and provide the selected count to an N-bit multiplexer 194 of the counter 186. In one embodiment, the multiplexer 192 selects the count based upon a roll-over signal indicative of whether the count of the counter 186 is to roll-over and a new frame signal indicative of whether a new frame 146 is to be sent on the audio bus 114.

More specifically, the multiplexer 192 may select the current count for the next count in response to the roll-over signal indicating that the counter 186 is not to roll-over and the new frame signal indicating that a new frame 146 is not being sent. Further, the multiplexer 192 may select the incremented count for the next count in response to the roll-over signal indicating that the counter 186 is not to roll-over and the new frame signal indicating that a new frame 146 is to be sent. Moreover, the multiplexer 192 may select the current count for the next count in response to the roll-over signal indicating that the counter 186 is to roll-over and the new frame signal indicating that a new frame 146 is not being sent. Finally, the multiplexer 192 may select the initial count for the next count in response to the roll-over signal indicating that the counter 186 is to roll-over and the new frame signal indicating that a new frame 146 is to be sent.

The counter 186 also may comprise an N-bit comparator 196 that provides the multiplexer 192 with the roll-over signal indicative of whether the count of the counter 186 is to roll-over. In particular, the comparator 196 may compare a roll-over value of the pace register 184 with the count of the latch 188 and may generate a roll-over signal that indicates the counter is to roll-over in response to the count having a predetermined relationship (e.g. equal) to the roll-over value (e.g. 4). Otherwise, the comparator 196 may generate a roll-over signal that indicates the count of the counter 186 is not to roll-over.

Based upon a control signal, the multiplexer 194 may select the initial count or the selected count of the multiplexer 192 as the next count of the counter 186. In one embodiment, the multiplexer 194 selects the count based upon a start signal indicative of whether to initial the count of the counter 186. More specifically, the multiplexer 194 may select the initial count for the next count in response to the start signal indicating that the count of the counter 186 is to be initialized. Further, the multiplexer 192 may select the selected count of the multiplexer 192 for the next count in response to the start signal indicating that the count of the counter 186 is not yet to be initialized.

The pace signal generator 198 of the command pacer 182 may generate a pace signal indicative of whether to block further commands to the codecs 112 or to allow further commands to the codecs 112 based upon the count of the counter 186. In one embodiment, the pace signal generator 198 may generate a pace signal to block further commands to the codecs 112 in response to the count having a predetermined relationship (e.g. not equal) to the initial count (e.g. 0). Further, the pace signal generator 198 may generate a pace signal to allow further commands to the codecs 112 in response to the count having a predetermined relationship (e.g. equal) to the initial count.

In one embodiment of the command pacer 182, the counter 186 may count frames 146 sent on the audio bus 114. Further, the pace signal generator 198 may generate the pace signal based upon the count of the counter 186 such that the audio controller 106 is allowed to send commands to the codecs 112 for one frame 146 of each cycle of the counter (e.g. each time the counter 186 rolls-over).

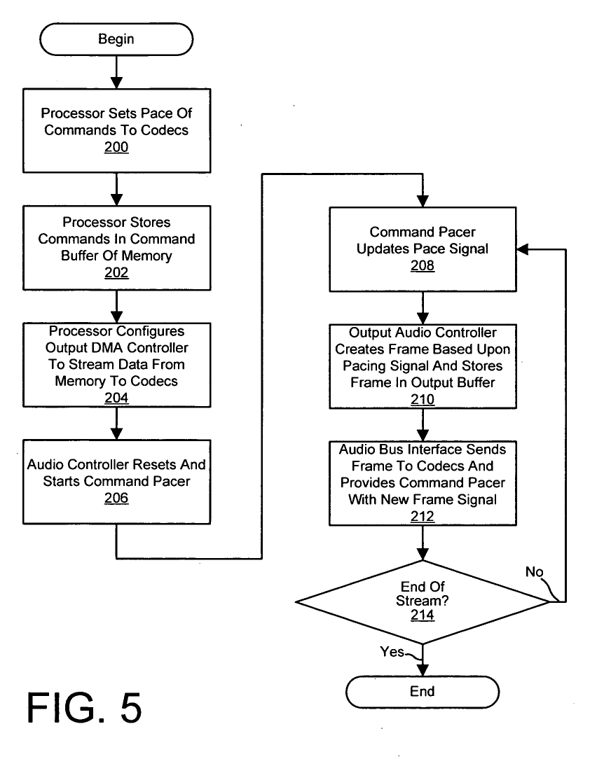

An embodiment of a method to stream data and commands to the codecs 112 is shown in FIG. 5. In box 200, the processor 100 may set a pace for sending commands to the codecs 112. In one embodiment, the processor 100 may set the command pace by writing a pace value to the pace register 184 of the audio controller 106. The processor 100 in box 202 may store one or more commands for the codecs 112 in the command buffer 116. In one embodiment, the processor 100 may write a command to the command entry 124 of the command buffer 116 identified by the write pointer 130. Furthermore, the processor 100 may update the write pointer 130 to identify a subsequent command entry 124 of the command buffer 116.

In box 204, the processor 100 may further configure the output DMA controller 178 to stream data from the memory 104 to one or more codecs 112. In one embodiment, the processor 100 may store a buffer descriptor list in the memory 104 that identifies the data to be streamed. Further, the processor 100 may request the output DMA controller 178 to stream data per the buffer descriptor list stored in the memory 104.

The audio controller 106 in response to the write to the pace register 184 may reset and start the command pacer 182 (box 206). In one embodiment, the audio controller 106 may force the start control line of the multiplexer 194 high in order to cause the multiplexer 194 to select the initial count (e.g. 0) for the next count of the counter 186 of the command pacer 182.

In box 208, the command pacer 182 may update the pace signal. In one embodiment, the command pacer 182 may determine whether to block/allow further commands to the codecs 112 in response to a new frame signal of the audio bus interface 144 and may update the pace signal accordingly. In particular, the counter 186 of the command pacer 182 may update its count in response to the new frame signal. Further, the pace signal generator 198 may determine based upon the count of the counter 186 whether to generate the pace signal to block further commands or to generate the pace signal to allow further commands. In one embodiment, the pace signal generator 198 of the command pacer 182 may determine to allow commands only when the count has a predetermined relationship (e.g. equal) to the predetermined count (e.g. 0). In such an embodiment, the command pacer 182 essentially allows a command to be sent each time its counter 186 rolls-over or is reset to the initial count and blocks commands from being sent whenever the counter 186 has a count other than the initial count.

The output DMA controller 178 in box 210 may create a frame 146 based upon the pace signal and may store the created frame 146 in the output buffer 150 for delivery to the codecs 112. In one embodiment, the output DMA controller 178 may read data for the frame 146 from the memory 104 per the buffer descriptor list provided by the processor 100. Further, in response to the pace signal indicating that further commands to the codecs 112 is permitted, the output DMA controller 178 may read a command from the command buffer 116 of the memory 104. In one embodiment, the output DMA controller 178 may read the command from the command entry 124 identified by the read pointer 132 and may update the read pointer 132 to identify a subsequent command entry 124 of the command buffer 116. The output DMA controller 178 may further create a frame 146 based upon the read data and command (if any) and store store the frame 146 in the output buffer 150 for delivery to one or more codecs 112.

The audio bus interface 144 in box 212 may send a frame 146 to the codecs 112 and may provide the command pacer 182 with a new frame signal that indicates that a frame 146 has been sent to the codecs 112. In one embodiment, the audio bus interface 144 may take a frame 146 from the output buffer 150 and may transmit the frame 146 to the codecs 112 via a broadcast link of the audio bus 114.

In response to the new frame signal, the command pacer 182 in box 214 may determine whether to block/allow further commands to the codecs 112. In one embodiment, the counter 186 of the command pacer 182 may update its count in response to the new frame signal. Further, the pace signal generator 198 may determine based upon the count of the counter 186 whether to generate the pace signal to block further commands or to generate the pace signal to allow further commands. In one embodiment, the pace signal generator 198 of the command pacer 182 may determine to allow commands only when the count has a predetermined relationship (e.g. equal) to the predetermined count (e.g. 0).

In box 216, the output DMA controller 178 may determine whether it has reached the end of the stream. In response to the output DMA controller 178 determining that the end of the stream has not yet been reached, the audio controller 106 may return to box 208 in order for the command pacer 182 to update the pace signal and the output DMA controller 178 to create another frame 146 for the codecs 112 based upon the updated pace signal.

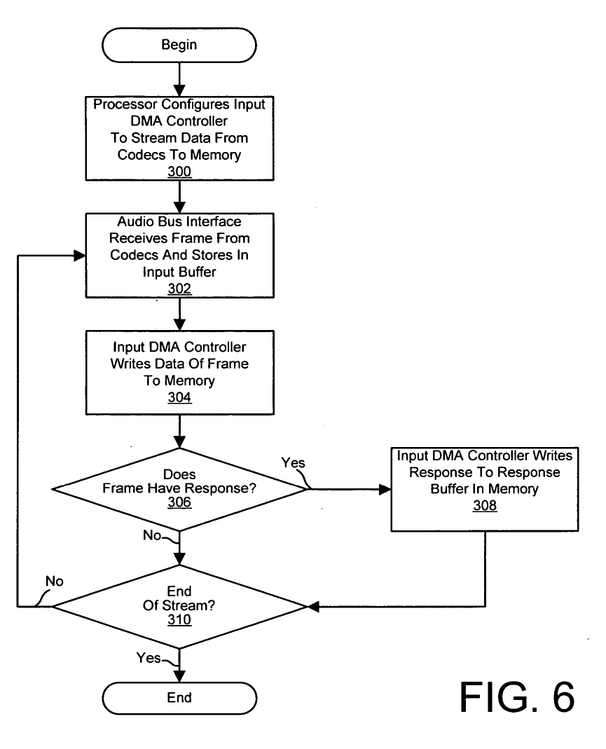

An embodiment of a method to stream data and responses from the codecs 112 to memory 104 is shown in FIG. 6. In box 300, the processor 100 may configure the input DMA controller 180 to stream data from one or more codecs 112 to the memory 104. In one embodiment, the processor 100 may store a buffer descriptor list in the memory 104 that identifies a stream buffer 120 to which the input DMA controller 180 is to write the data received from the codecs 112. Further, the processor 100 may request the input DMA controller 180 to stream data per the buffer descriptor list stored in the memory 104.

The audio bus interface 144 in box 302 may receive a frame 146 from the codecs 112 and may store the frame 146 in the input buffer 148 for delivery to the stream buffer 120 in memory 104. The input DMA controller 180 in box 304 may take a frame 146 from the input buffer 148 and may write the data of the frame 146 to its stream buffer 120 per the buffer descriptor list provided by the processor 100. In box 306, the input DMA controller 180 may determine whether a response is present in the command/response field 158 of the frame 146. In response to determining that a response is present, the input DMA controller 180 in box 308 may write the response to the response buffer 118 of the memory 104. In one embodiment, the input DMA controller 180 may write the response to the response entry 134 identified by the write pointer 140 and may update the write pointer 140 to identify a subsequent response entry 134 of the response buffer 118.

In box 310, the input DMA controller 180 may determine whether it has reached the end of the stream. In response to the input DMA controller 180 determining that the end of the stream has not yet been reached, the audio controller 106 may return to box 302 in order for the audio bus interface 144 to receive another frame 146 from the codecs 112.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

1. A method comprising
generating a pace signal indicative of whether sending further commands from a command buffer to a codec is permitted, and
sending commands to the codec at a pace set by the pacing signal.

2. The method of claim 1 wherein generating the pace signal comprises periodically generating the pace signal to indicate that sending further commands to the codec is permitted.

3. The method of claim 1 wherein generating the pace signal comprises periodically generating the pace signal to indicate that sending further commands to the codec is not permit.

4. The method of claim 1 further comprising
sending frames of data to the codec,
generating a new frame signal in response to each frame sent to the codec, and
updating the pace signal in response to the new frame signal.

5. The method of claim 1 further comprising
sending frames of data to the codec,
generating new frame signals in response to frames sent to the codec, and
updating the pace signal in response to the new frame signals such that the pace signal indicates that sending further commands is permitted for a first number of frames and that sending further commands is not permitted for a second number of frames.

6. The method of claim 5 further comprising
receiving a pace value, and
defining the second number of frames in which sending further commands is not permitted based upon the pace value.

7. An audio controller for a codec comprising
a command pacer to control a command pace at which commands are transferred to the codec, and
a DMA controller to transfer commands from a command buffer of a memory to the codec based upon the command pace of the command pacer.

8. The audio controller of claim 7 wherein the DMA controller further transfers data from the memory to the codec.

9. The audio controller of claim 8 further comprising
an output buffer to store frames, and
an audio bus interface to transfer frames from the output buffer to the codec, wherein
the DMA controller creates frames based upon the data and commands read from the memory and stores created frames in the output buffer for delivery to the codec.

10. The audio controller of claim 9 wherein
the audio bus interface generates new frame signals in response to transferring frames to the codec, and
the command pacer controls controls the command pace based upon the new frame signals.

11. The audio controller of claim 9 wherein the command pacer comprises
a roll-over counter to update a count in response to each frame transferred to the codec, and
a pace signal generator to generate a pace signal based upon the count of the roll-over counter that is indicative of the command pace.

12. The audio controller of claim 11 wherein the pace signal generator generates the pace signal to allow further commands to the codec when the count of the roll-over counter has a predetermined relationship to a predetermined count of the roll-over counter.

13. A system comprising
memory comprising a command buffer and stream buffer,
a codec to process data and commands,
an audio controller to stream data from the stream buffer to the codec and to transfer commands from the command buffer to the codec at a programmable pace.

14. The system of claim 13 wherein
the memory further comprises a response buffer,
the codec further generates responses in response to processing the commands, and
the audio controller further streams the responses from the codec to the response buffer.

15. The system of claim 13 wherein
the memory further comprises a buffer descriptor list that defines the stream buffer, and
the audio controller streams the data from the stream buffer per the buffer descriptor list.

16. The system of claim 13 wherein the audio controller
creates frames from the data and the commands,
transfers the frames to the codec, and
controls the programmable pace based upon the frames transferred to the codec.

17. The system of claim 13 wherein the audio controller
receives a pace value, and
transfers at most one command to the codec per a number of frames transferred to the codec that is equal to the pace value.

18. A machine-readable medium comprising a plurality of instructions that, in response to being executed, result in a computing device
storing commands in a command buffer of a memory,
setting a command pace, and
transferring the commands to a codec at the command pace.

19. The machine-readable medium of claim 18 wherein the plurality of instructions further result in the computing device
storing data in a stream buffer of the memory, and
transferring the data from the stream buffer to the codec in frames.

20. The machine-readable medium of claim 19 wherein the plurality of instructions further result in the computing device placing the commands in a portion of the frames transferred to the codec that is based upon the command pace.

21. The machine-readable medium of claim 18 wherein the plurality of instructions further result in the computing device processing responses of the codec from a response buffer of the memory.
